(19) United States
(12) Patent Application Publication
(10) Pub. No.: US 2026/0180437 A1
(43) Pub. Date: Jun. 25, 2026

(54) CHARGE PUMP CIRCUIT

(71) Applicant: REALTEK SEMICONDUCTOR CORP., Hsinchu (TW)

(72) Inventors: Wei-Yang Chang, Hsinchu (TW); Chia-Wei Yu, Hsinchu (TW); Chieh-Pin Chang, Hsinchu (TW); Yung-Tai Chen, Hsinchu (TW); Hui-Min Huang, Hsinchu (TW)

(73) Assignee: REALTEK SEMICONDUCTOR CORP., Hsinchu (TW)

(21) Appl. No.: 19/424,816

(22) Filed: Dec. 18, 2025

(30) Foreign Application Priority Data
Dec. 19, 2024 (TW) 113149722

(51) Int. Cl. H02M 1/44; H02M 3/00; H02M 3/07

(52) U.S. Cl. CPC H02M 1/44; H02M 3/003; H02M 3/07

(57) ABSTRACT

A charge pump circuit includes a charge pump stage and a filtering stage. The charge pump stage has an output terminal, and the filtering stage is coupled to the output terminal. The filtering stage includes a plurality of low-pass filters coupled in series. Each low-pass filter includes a capacitor assembly. Each capacitor assembly includes a plurality of interdigitated capacitors, and the interdigitated capacitors in one capacitor assembly have a first interdigitated spacing. The interdigitated capacitors of another capacitor assembly have a second interdigitated spacing different from the first interdigitated spacing.

### CROSS-REFERENCE TO RELATED APPLICATION

This non-provisional application claims priority under 35 U.S.C. § 119(a) to Patent Application No. 113149722 filed in Taiwan, R.O.C. on Dec. 19, 2024, the entire contents of which are hereby incorporated by reference.

### BACKGROUND

### Technical Field

The present disclosure provides a charge pump circuit, and particularly relates to a charge pump circuit capable of optimizing the quality of output signals.

### Related Art

Charge pump is to utilize a capacitor as a main energy storage element to increase the voltage, and utilize a clock signal in each cycle to transfer the charge from one capacitor to another capacitor so as to effectively pump the charge in a specific direction, and thereby changing the voltage at an output terminal of the charge pump. However, if a back-end circuit is an audio application circuit or other circuits with strict requirements for signal quality, it may be usually affected by noise interference in a voltage signal from the pumped charge.

### SUMMARY

In view of this, in some embodiments, a charge pump circuit is provided, which includes a charge pump stage and a filtering stage. The charge pump stage has an output terminal. The filtering stage is coupled to the output terminal, and includes a plurality of low-pass filters coupled in series. Each low-pass filter includes a capacitor assembly. Each capacitor assembly includes a plurality of interdigitated capacitors, and the interdigitated capacitors in one capacitor assembly have a first interdigitated spacing. The interdigitated capacitors of another capacitor assembly have a second interdigitated spacing different from the first interdigitated spacing.

In conclusion, according to some embodiments, the charge pump circuit is provided with multi stages of low-pass filters, and the capacitor assemblies of the multi stages of low-pass filters are implemented by the interdigitated capacitors having non-uniform interdigitated spacing. Therefore, low leakage current and reduction of capacitor area can be considered at the same time, so as to realize low noise level and capacitor area optimization.

The detailed features and advantages of the present disclosure are described in detail in the embodiments below, and the contents are sufficient for those skilled in the art to understand the technical content of the present disclosure and implement it correspondingly, and according to the contents disclosed in this specification, the scope of the claims and the drawings, any person skilled in the art can easily understand the relevant purposes and advantages of the present disclosure.

### BRIEF DESCRIPTION OF THE DRAWINGS

FIG. 1 is a circuit block diagram of a charge pump circuit in some embodiments of the present disclosure.

FIG. 2 is a circuit architecture diagram of a charge pump circuit in some embodiments of the present disclosure.

FIG. 3 is a schematic diagram of an interdigitated layer of an interdigitated capacitor in some embodiments of the present disclosure.

FIG. 4 is a partial enlarged diagram of a region 4 in FIG. 3.

FIG. 5 is a circuit block diagram of a charge pump circuit in some embodiments of the present disclosure.

FIG. 6 is a circuit architecture diagram of a charge pump circuit in some embodiments of the present disclosure.

FIG. 7 is a relationship diagram of interdigitated spacing, leakage current, and capacitance value of a metal-oxide-metal capacitor under different operating voltages in some embodiments of the present disclosure.

### DETAILED DESCRIPTION

Various embodiments are presented below for detailed description, and the embodiments are only used as examples and do not limit the scope of protection of the present disclosure. In addition, some elements are omitted in the drawings in the embodiments to clearly show the technical features of the present disclosure. The same reference numerals will be used for representing the same or similar elements in all drawings.

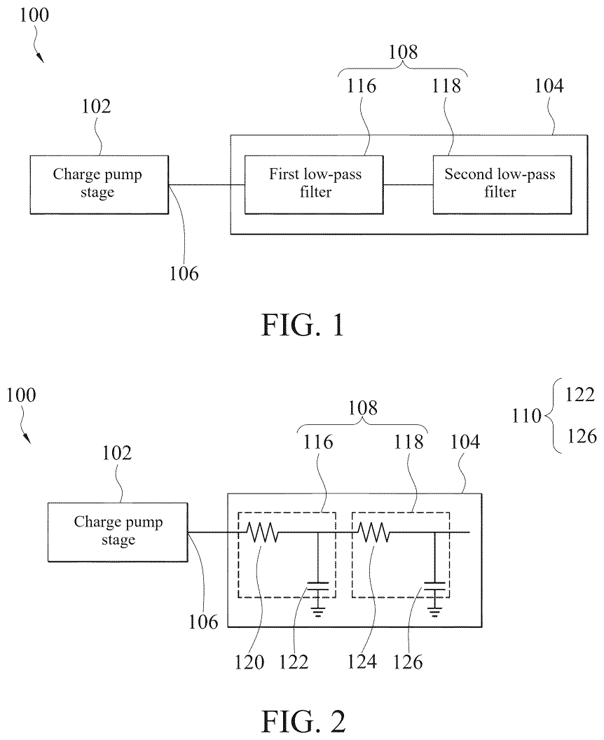

Referring to FIG. 1 and FIG. 2 together. In some embodiments, as shown in FIG. 1 and FIG. 2, a charge pump circuit 100 includes a charge pump stage 102 and a filtering stage 104. The charge pump stage 102 has an output terminal 106. The charge pump stage 102 may receive an input signal, and adjust a voltage of the input signal to generate a voltage signal at the output terminal 106. In some embodiments, the charge pump stage 102 may be a cross-coupled charge pump.

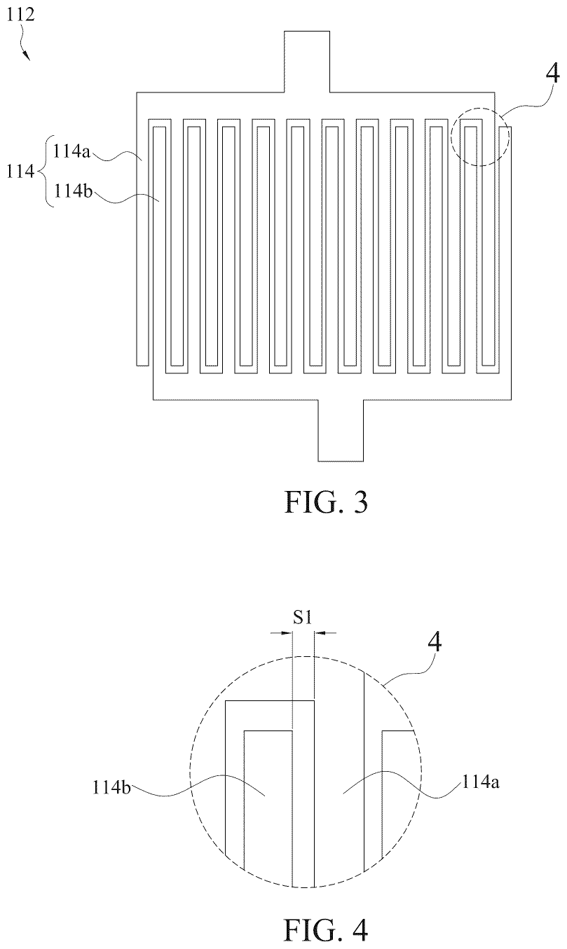

The filtering stage 104 is coupled to the output terminal 106 and configured to perform multi-stage filtering on the voltage signal, so as to output a pump voltage at the last stage of filtering. The filtering stage 104 includes a plurality of low-pass filters 108 coupled in series. In some embodiments, the low-pass filters 108 are RC filters. Each low-pass filter 108 includes a capacitor assembly 110. Each capacitor assembly 110 includes a plurality of interdigitated capacitors 112. As shown in FIG. 3, it is a schematic diagram of an interdigitated layer of an interdigitated capacitor 112 in some embodiments of the present disclosure. The interdigitated capacitor 112 is a metal-oxide-metal (MOM) capacitor. The metal-oxide-metal capacitor is a capacitor used in an integrated circuit. Each metal-oxide-metal capacitor is provided with a plurality of interdigitated layers (which are made of a conductive material such as metal). Each interdigitated layer is of an interdigitated structure 114. The interdigitated structures 114 are stacked to form a capacitor cell, namely the capacitor assembly 110.

Referring to FIG. 4, it is a partial enlarged diagram of a region 4 in FIG. 3. The interdigitated structures 114 have an interdigitated spacing S1. Specifically, the interdigitated structures 114 are formed by a plurality of first interdigitated substructures 114a and a plurality of second interdigitated substructures 114b which are arranged in a staggered way. The present disclosure is not limited to the interdigitated shape shown in FIG. 3 and FIG. 4. The spacing between one first interdigitated substructure 114a and an adjacent second interdigitated substructure 114b is the interdigitated spacing S1. The interdigitated spacing S1 is in negative correlation with the capacitance value of the interdigitated capacitors 112. For example, the capacitance value is smaller when the interdigitated spacing S1 is increased. Otherwise, the capacitance value is larger when the interdigitated spacing S1 is reduced.

In an example, the filtering stage 104 is a two-stage filtering low-pass filter 108. As shown in FIG. 1, the filtering stage 104 includes a first low-pass filter 116 and a second low-pass filter 118. The first low-pass filter 116 is coupled to the output terminal 106, and is configured to receive the voltage signal, and first-stage filtering is performed on the voltage signal to generate a first-stage voltage. The second low-pass filter 118 is coupled to the first low-pass filter 116, and is configured to receive the first-stage voltage, and second-stage filtering is performed on the first-stage voltage to generate a second-stage voltage. The second-stage voltage is outputted as a pump voltage. In this way, when the charge pump circuit 100 adjusts the voltage, the voltage signal is subjected to the first-stage filtering and the second-stage filtering to remove high-frequency noise in the voltage signal.

As shown in FIG. 2, the first low-pass filter 116 and the second low-pass filter 118 are the RC filters. The first low-pass filter 116 is provided with a first resistor 120 and a first capacitor assembly 122. The second low-pass filter 118 is provided with a second resistor 124 and a second capacitor assembly 126. The first capacitor assembly 122 and the second capacitor assembly 126 respectively include a plurality of interdigitated capacitors 112. The interdigitated capacitors 112 included in the first capacitor assembly 122 are defined as first interdigitated capacitors, and the interdigitated capacitors 112 included in the second capacitor assembly 126 are defined as second interdigitated capacitors. The interdigitated spacing S1 of the interdigitated structures 114 of the first interdigitated capacitors is a first interdigitated spacing. The interdigitated spacing S1 of the interdigitated structures 114 of the second interdigitated capacitors is a second interdigitated spacing. Specifically, the first interdigitated capacitors include a plurality of first interdigitated layers, and the first interdigitated layers are respectively provided with the interdigitated structures 114 having the first interdigitated spacing. The second interdigitated capacitors include a plurality of second interdigitated layers, and the second interdigitated layers are respectively provided with the interdigitated structures 114 having the second interdigitated spacing. In the embodiment shown in FIG. 2, the second interdigitated spacing is smaller than the first interdigitated spacing, thus the number of the second interdigitated capacitors is decreased to save the area. Therefore, the first capacitor assembly 122 has a first capacitance value, and the second capacitor assembly 126 has a second capacitance value. The first capacitance value is smaller than the second capacitance value.

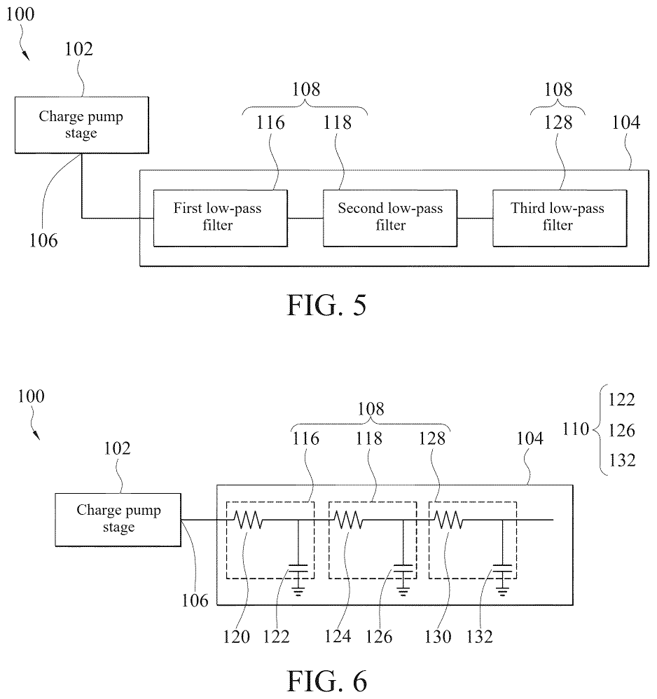

In another example, as shown in FIG. 5 and FIG. 6, compared with the example shown in FIG. 1 and FIG. 2, the charge pump circuit 100 further includes a third low-pass filter 128. The third low-pass filter 128 is an RC filter. The third low-pass filter 128 is coupled to the second low-pass filter 118, and is provided with a third resistor 130 and a third capacitor assembly 132. The first low-pass filter 116, the second low-pass filter 118, and the third low-pass filter 128 can form a three-stage low-pass filter. The third capacitor assembly 132 includes a plurality of interdigitated capacitors 112 (hereinafter referred to as third interdigitated capacitors). The interdigitated spacing S1 of the interdigitated structures 114 of the third interdigitated capacitors is a third interdigitated spacing. Specifically, the third interdigitated capacitors include a plurality of third interdigitated layers, and the third interdigitated layers are respectively provided with the interdigitated structures 114 having the third interdigitated spacing. The second interdigitated spacing or the third interdigitated spacing is smaller than the first interdigitated spacing, so that the number of the second interdigitated capacitors or the third interdigitated capacitors is correspondingly decreased to save the area. In some embodiments, the third interdigitated spacing can be set to be smaller than or equal to the second interdigitated spacing. When the third interdigitated spacing is smaller than the second interdigitated spacing, the number of the third interdigitated capacitors is further decreased to further save the area. Therefore, the first capacitor assembly 122 has the first capacitance value, the second capacitor assembly 126 has the second capacitance value, and the third capacitor assembly 132 has a third capacitance value. The first capacitance value is smaller than the second capacitance value, and the second capacitance value is smaller than the third capacitance value.

According to the description of the above examples, the capacitor assembly 110 in each low-pass filter 108 in the filtering stage 104 is not implemented by the interdigitated capacitors 112 having the unified interdigitated spacing S1. That is, the capacitor assemblies 110 contained in the plurality of low-pass filters 108 in the filtering stage 104 have two or more interdigitated spacing S1. For example, the interdigitated capacitors 112 in one capacitor assembly 110 have the first interdigitated spacing, and the interdigitated capacitors 112 in another capacitor assembly 110 have the second interdigitated spacing different from the first interdigitated spacing. Therefore, the area of the capacitor assemblies 110 can be reduced. Particularly, in a case that the capacitance value of the capacitor assembly 110 of the low-pass filter 108 at each stage is increased step by step, the low-pass filter 108 at a tail end of the adjacent filtering stage 104 is provided with the capacitor assembly 110 having smaller interdigitated spacing S1, and thus the number of the capacitor assembly 110 in the low-pass filter 108 at the tail end can be effectively reduced. For example, the interdigitated spacing S1 of the capacitor assembly 110 in the low-pass filter 108 at the tail end is smaller than the interdigitated spacing S1 of the capacitor assembly 110 in the low-pass filter 108 at a head end.

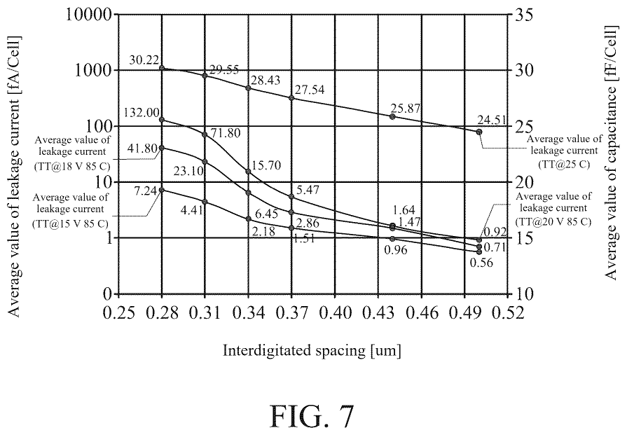

Referring to FIG. 7, FIG. 7 shows capacitance values and leakage current situations of a metal-oxide-metal capacitor having differential interdigitated spacing S1 under different operating voltages. For example, when the interdigitated spacing S1 is 0.28 um, the capacitance value is 30.22 fF. When the interdigitated spacing S1 is 0.50 um, the capacitance value is 24.51 fF. The leakage current is observed, and under three operating voltages (20 V, 18 V, and 15 V), the leakage currents of the interdigitated capacitors 112 having the interdigitated spacing S1 of 0.28 um are 132.00 fA, 41.80 fA, and 7.24 fA respectively. Under the three operating voltages (20 V, 18 V, and 15 V), the leakage currents of the interdigitated capacitors 112 having the interdigitated spacing S1 of 0.5 um are 0.92 fA, 0.71 fA, and 0.56 fA respectively. Therefore, when the interdigitated spacing S1 is smaller, the obtained capacitance value is larger, but the caused leakage current is larger. Moreover, in a smaller interdigitated spacing S1 interval (such as 0.28 um to 0.37 um), the higher the operating voltage, the more intense the leakage current. Therefore, the design of the interdigitated spacing S1 of the interdigitated capacitors 112 meets the required capacitance value and also needs to consider the leakage current at the same time. If the leakage current of the interdigitated capacitors 112 is increased, a capacitance voltage will be insufficient, and thereby reducing the filtering effect. If the interdigitated spacing S1 is enlarged to reduce the leakage current, the capacitance value of the interdigitated capacitors 112 will be reduced, consequently, more interdigitated capacitors 112 are needed to meet the requirement of the capacitance value, and as a result, the overall area of the capacitors is enlarged.

It is to be noted that when the pump voltage outputted by the charge pump circuit 100 is applied to an audio circuit (namely, the pump voltage is used as a working voltage of the audio circuit), it is particularly needed to control the leakage current of the charge pump circuit 100 within a certain range to maintain the filtering effect, so as to realize extremely low noise level and avoid influencing the signal quality of the audio circuit, but the present disclosure is not limited to the audio circuit.

Two specific examples are compared for illustrating below, and the three-stage filter circuit shown in FIG. 5 and FIG. 6 is taken as an example. Table 1 is a comparative example, the first capacitor assembly 122, the second capacitor assembly 126, and the third capacitor assembly 132 use the metal-oxide-metal capacitors having the same interdigitated spacing S1, and 0.5 um is taken as an example here. Here, five interdigitated layers (M1-M5) are provided in the metal-oxide-metal capacitor, and the present disclosure is not limited to this. When the output voltage of the filter at each stage is 20 V, 18 V, and 15 V in sequence, and the required capacitance value is 4000 fF, 8000 fF, and 20000 fF in sequence, as shown in FIG. 7, the leakage current and the number of capacitor cells of each of the capacitor assemblies (122, 126, and 132) shown in Table 1 can be obtained. Therefore, in the comparative example, the total leakage current is 838.8 fA, and 1307 capacitor cells are provided.

TABLE 1

| | | Number of | Leakage | Operating | Interdigitated |
|---|---|---|---|---|---|
| | Capacitance | capacitor | current | voltage | spacing (um) |
| | value (fF) | cells | (fA) | (V) | M1-M4/M5 |
| First capacitor | 4000 | 163 | 150.1 | 20 | 0.5/0.5 |
| assembly 122 | | | | | |
| Second capacitor | 8000 | 326 | 231.7 | 18 | 0.5/0.5 |
| assembly 126 | | | | | |
| Third capacitor | 20000 | 818 | 457.0 | 15 | 0.5/0.5 |
| assembly 132 | | | | | |

Table 2 is an embodiment of the present disclosure, and the first capacitor assembly 122, the second capacitor assembly 126, and the third capacitor assembly 132 are not implemented by the metal-oxide-metal capacitors having the uniform interdigitated spacing S1. The interdigitated spacing S1 of each interdigitated layer of the metal-oxide-metal capacitor in the first capacitor assembly 122 is 0.5 um; and the interdigitated spacing S1 of the first to fourth layers of the metal-oxide-metal capacitor in the second capacitor assembly 126 and the third capacitor assembly 132 are 0.34 um, and the interdigitated spacing S1 of the fifth layer is 0.44 um. Therefore, the second interdigitated spacing and the third interdigitated spacing are both smaller than the first interdigitated spacing (here, comparison is performed by the interdigitated spacing S1 of the corresponding interdigitated layers, such as comparison of the M1 layers of the metal-oxide-metal capacitors in the first capacitor assembly 122 and the second capacitor assembly 126). In a case of the same operating voltage and capacitance value as the comparative example, as shown in FIG. 7, the leakage current and the number of capacitor cells of each of the capacitor assemblies (122, 126, 132) shown in Table 2 can be obtained. Therefore, in the embodiment, the total leakage current is 3498.7 fA, and 1147 capacitor cells are provided.

TABLE 2

| | | Number of | Leakage | Operating | Interdigitated |
|---|---|---|---|---|---|
| | Capacitance | capacitor | current | voltage | spacing (um) |
| | value (fF) | cells | (fA) | (V) | M1-M4/M5 |
| First capacitor | 4000 | 163 | 150.1 | 20 | 0.5/0.5 |
| assembly 122 | | | | | |
| Second capacitor | 8000 | 281 | 1815.0 | 18 | 0.34/0.44 |
| assembly 126 | | | | | |
| Third capacitor | 20000 | 703 | 1533.6 | 15 | 0.34/0.44 |
| assembly 132 | | | | | |

The two examples are compared, although the total leakage current of the filtering stage 104 in the Table 2 is increased to 3498.7 fA, the overall leakage current can still be controlled within 10 pA. In addition, the number of capacitor cells in the Table 2 is reduced by 12% compared with that in the Table 1, and the overall area of the capacitors is effectively reduced. Therefore, the low noise level and the optimization of the capacitor area are realized. Particularly, in a case that the capacitance value of the capacitor assembly 110 in the low-pass filter 108 at each stage is increased step by step, the interdigitated spacing S1 of the capacitor assembly 110 in the low-pass filter 108 at the tail end is smaller than that of the capacitor assembly 110 in the low-pass filter 108 at the head end, and thus the capacitor area can be effectively reduced. In some embodiments, the interdigitated spacing S1 of the capacitor assembly 110 in the low-pass filter 108 at the tail end ranges from 0.34 um to 0.5 um.

In conclusion, according to some embodiments, the charge pump circuit 100 is provided with multi stages of low-pass filters 108, and the capacitor assemblies 110 of the multi stages of low-pass filters 108 are implemented through the interdigitated capacitors 112 having non-uniform interdigitated spacing S1. Therefore, the low leakage current and the reduction of capacitor area can be considered at the same time, and the low noise level and the optimization of the capacitor area are realized.

The above-mentioned embodiments are only to illustrate the technical ideas and characteristics of the present disclosure, and their purpose is to enable those skilled in the art to understand the content of the present disclosure and implement it correspondingly, and it cannot be used for limiting the scope of patent of the present disclosure, that is, all equal changes or modifications made in accordance with the spirit revealed in the present disclosure should still be covered within the scope of the claims of the present disclosure.

What is claimed is:

1. A charge pump circuit, comprising:
a charge pump stage having an output terminal; and
a filtering stage coupled to the output terminal and comprising a plurality of low-pass filters coupled in series, wherein each low-pass filter comprises a capacitor assembly, each capacitor assembly comprises a plurality of interdigitated capacitors, the interdigitated capacitors in one capacitor assembly have a first interdigitated spacing, and the interdigitated capacitors of another capacitor assembly have a second interdigitated spacing different from the first interdigitated spacing.

2. The charge pump circuit according to claim 1, wherein the interdigitated spacing of the capacitor assembly of the low-pass filter at a tail end is smaller than that of the capacitor assembly of the low-pass filter at a head end.

3. The charge pump circuit according to claim 2, wherein the interdigitated spacing of the capacitor assembly of the low-pass filter at the tail end ranges from 0.34 um to 0.5 um.

4. The charge pump circuit according to claim 1, wherein the low-pass filters comprise:
a first low-pass filter, coupled to the output terminal, the capacitor assembly contained in the first low-pass filter is a first capacitor assembly; and
a second low-pass filter, coupled to the first low-pass filter, the capacitor assembly contained in the second low-pass filter is a second capacitor assembly;
wherein the interdigitated capacitors of the first capacitor assembly have the first interdigitated spacing, the interdigitated capacitors of the second capacitor assembly have the second interdigitated spacing, and the second interdigitated spacing is smaller than the first interdigitated spacing.

5. The charge pump circuit according to claim 4, wherein the first capacitor assembly has a first capacitance value, the second capacitor assembly has a second capacitance value, and the first capacitance value is smaller than the second capacitance value.

6. The charge pump circuit according to claim 1, wherein the low-pass filters comprise:
a first low-pass filter, coupled to the output terminal, the capacitor assembly contained in the first low-pass filter is a first capacitor assembly;
a second low-pass filter, coupled to the first low-pass filter, the capacitor assembly contained in the second low-pass filter is a second capacitor assembly; and
a third low-pass filter, coupled to the second low-pass filter, the capacitor assembly contained in the third low-pass filter is a third capacitor assembly;
wherein the interdigitated capacitors of the first capacitor assembly have the first interdigitated spacing, the interdigitated capacitors of the second capacitor assembly have the second interdigitated spacing, the interdigitated capacitors of the third capacitor assembly have a third interdigitated spacing, and the second interdigitated spacing or the third interdigitated spacing is smaller than the first interdigitated spacing.

7. The charge pump circuit according to claim 6, wherein the third interdigitated spacing is smaller than or equal to the second interdigitated spacing.

8. The charge pump circuit according to claim 6, wherein the first capacitor assembly has a first capacitance value, the second capacitor assembly has a second capacitance value, and the third capacitor assembly has a third capacitance value; and wherein the first capacitance value is smaller than the second capacitance value, and the second capacitance value is smaller than the third capacitance value.

9. The charge pump circuit according to claim 1, wherein a total leakage current of the capacitor assemblies is smaller than 10 picoampere (pA).

10. The charge pump circuit according to claim 1, wherein the interdigitated capacitors are metal-oxide-metal capacitors.
